(19) United States
(12) Patent Application Publication
(10) Pub. No.: US 2008/0094179 A1
(43) Pub. Date: Apr. 24, 2008

(54) Identification device for objects with a transponder and a corresponding method

(75) Inventors: Mauro Di Domenico, Bironico (CH); Nicola Brilli, Cureglia (CH)

Correspondence Address: George Pappas;Suite 300, 919 S. Harrison Street, Fort Wayne, IN, 46802, US

(73) Assignee: Datamars SA

(21) Appl. No.: 11/974,768

(22) Filed: Oct. 16, 2007

(30) Foreign Application Priority Data
Oct. 20, 2006 (EP) EP 06 022 015.9

(51) Int. Cl. H04B 7/00

(52) U.S. Cl. 340/10.1

(57) ABSTRACT

In order to achieve an optimal identification with an identification device for objects that comprise a transponder and are transported by means of a conveyor device through a closed tunnel (2), it is proposed that the antenna device of the transmitting and receiving device (10) comprises at least three sequentially arranged coil-shaped antennas (4, 6, 8). They surround the tunnel (2), each lying in a plane and representing a linearly independent system. The antennas (4, 6, 8) are operated in a multiplexer mode.

This application claims priority of application EP 06 022 015 having a priority date of Oct. 20, 2006, the disclosure of which is hereby incorporated by reference.

### FIELD OF THE INVENTION

The invention relates to an identification device for objects with a transponder, with a conveyor device for the objects to be identified as well as to a corresponding identification method.

### BACKGROUND OF THE INVENTION

In general, a transponder is understood to be a communication element that receives incoming signals and responds thereto. Thus, the term “transponder” is made up of the English terms “transmitter” and “responder”. Transponders can be passive or active.

Passive transponders are systems that draw the power required for communication and for executing internal processes exclusively from the field of the recording/reading unit. Therefore, passive transponders operate without self-power. In contrast, active systems have their own power supply, frequently in the form of batteries. In addition to the pure forms of passive and active systems, there exist semi-active transponders. In the following, the term transponder will be used in the sense of a passive transponder.

A passive transponder allows one to identify an object. Examples therefor are pet registration elements which, for example, can be implanted into the pets. An active receiving and reading unit in combination with a storage circuitry or a computer records and decodes the data that are present in the passive transponder. Some of these transponders meet international standards, e.g. DIN/ISO 11784/11785 (FDX-B), and can be read out easily by means of handheld reading devices.

In contrast, for other applications such as e.g. the identification of laundry items in a laundry facility of industrial size, usually one does not record separately with a handheld reading device every laundry item provided with a transponder. Rather than that, the laundry items are usually loaded into a container or—alternatively—simply onto a transport band; an identification device shall then be able to record all the laundry items that are present in the container and to store the codes thereof. In doing so, a variety of difficulties arise.

In the presence of a plurality of transponders, the reading device is exposed to a plurality of back-transmitted codes, which for system-intrinsic reasons are all sent out with the same frequency. Therefore, measures have to be taken in order to distinguish these back-transmitted codes, but also to enable the distinction to be carried out as system-conform as possible. For one thing, a so called “quiet mode” is available. Once the transponder is identified, it is possible to send a command to it that causes the transponder to no longer send back its code as long as it can remember the command. Obviously, with a purely passive transponder this operating mode only works as long as the transponder is supplied with power. With these well-known provisions, it is possible to identify a very large number of transponders within an ensemble.

In order to maximize the transiting velocity of the container through the conveyor device, it is proposed in JP-A-11/149528 to couple the conveyor band velocities with the reading rate and to regulate them correspondingly, albeit without being able to solve the problems described above.

Indeed, further problems arise because the H-field antennas that necessarily are used by the reading device—usually coils that are brought close to the ensemble, cannot interact with any transponder antennas whose coil plane is perpendicular to or forms a large angle with the coil plane of the antenna coils of the reading device. This problem needs to be solved as well.

JP-A-2004/244140 proposes an antenna arrangement wherein two antennas are arranged at a predefined angle of about 90°, the coils of the two antennas either touching each other or having but a very small distance at one side thereof. In this way it is attempted to improve detection of transponders with different orientation.

In EP-A-1 688 863 it is proposed that a container filled with a plurality of objects provided with transponders be sent through a tunnel by means of a conveyor band, the tunnel being surrounded by three antennas. A first antenna shall be arranged transversely around the tunnel entrance. A second antenna shall be arranged directly behind the tunnel entrance at one side of the tunnel at an angle of about 45° and extending in transport direction to the other side of the tunnel until about the end of the tunnel. A third antenna shall be arranged directly behind the tunnel entrance at the other side of the tunnel at an angle of about 45° and extending in transport direction to the first side of the tunnel until about the end of the tunnel—essentially crosswise to the is second antenna. Moreover, the antenna arrangement proposed in EP-A-1 688 863 comprises an antenna covering the underside of the tunnel. Particularly the antenna that is not arranged around the tunnel has turned out to be disadvantageous since it is not able to contribute much in identifying the transponders. An arrangement that is very similar to the crossed antenna arrangement is known from JP-A-2004/192223, which, however, does not offer any further advantages for solving the problems that arise.

A complex further development of this solution is presented in US-A-2004/0036623. At the outset, a plurality of antennas is arranged in sheet-like manner around the tunnel so that the antenna planes are parallel to the tunnel walls. These antennas cannot contribute much to the solution of the above mentioned problem. In addition, there are also tunnel antennas, the antenna coils, which surround the tunnel. One such tunnel antenna shall be arranged in such way that the planes thereof are perpendicular to the normal of the conveyor tape. Moreover, there are two further antennas surrounding the tunnel which are of the type already recognized to be disadvantageous in the above described arrangement, which antennas are at a certain angle and form an approximately linearly independent system, the coils of the two antennas even overlapping each other at one side thereof. Although this solution comprises a large number of antennas, it cannot solve the problem described hereinbelow.

In fact, a further problem is known, namely the presence of two or more transponders in close proximity to each other, which mutually interfere even when they are not aligned in the same direction.

### SUMMARY OF THE INVENTION

It is an object of the invention to provide an identification device for transponders that is capable to identify a plurality of transponders that are present in a container being transported over a conveyor band or that are just loosely arranged on the conveyor band, thereby overcoming or at least alleviating the problems of the arrangements known in the art. It is required that identification of all the transponders arranged in the container or loosely on the conveyor band shall be possible. In the following, a container shall be understood as any device that is capable of taking up any objects of interest having a transponder, e.g. such device may include laundry bags etc.

The object of the invention is achieved by means of an identification device each of which comprises a transponder, with a conveyor device for the objects to be identified, the conveyor device comprising a tunnel through which the objects to be identified are transportable, a transmitting and receiving device for communication with the transponders of the objects to be identified, the transmitting and receiving device comprising an processing device and an antenna device, the antenna device comprising at least three sequentially arranged coil-shaped antennas that surround the tunnel, at least three of the antennas that surround the tunnel lying each in a different plane (x′, y′, z′), the planes (x′, y′, z′) representing a linearly independent system wherein said antenna planes (x′, y′, z′) do not intersect or contact each other within the tunnel. As a result of the features of this invention, a plurality of transponders having any arbitrary orientation within the antenna tunnel can be identified.

It is particularly advantageous if the transmitting and receiving device is set up so that the antennas may be operated in the multiplexer mode. Such a method is also called multiplexing procedure. This procedure not only allows making optimum use of the electronics, but it also allow minimizing the overlap of the various antenna/transponder interactions. In order to achieve an optimum temporal separation between the measurements carried out with the various antennas, it is advantageous that the antenna planes within the tunnel have a distance of at least 10 mm and that the first plane be preferably parallel to the transport direction of the conveyor band.

The objects bearing the identification carriers are usually transported through the tunnel in containers. For smaller containers that are not larger than the distance between the first antenna plane and the third antenna plane, in which case it is not probable for transponders to be already identified with the third antenna while other transponders are still being identified with the first antenna, it is advantageous if the transmitting and receiving device is set up so that initially it activates the first antenna. During identification of transponders with the first antenna, as many transponders as possible are identified therewith and, simultaneously, the second antenna is alternatingly activated in the multiplexer mode and identifies as many transponders as possible. Once the first antenna no longer identifies any transponders, the third antenna is alternatingly activated in the multiplexer mode, and as many transponders as possible are identified with the second and third antenna until the second antenna no longer identifies any transponders. Thereafter, the third antenna is kept in operation until it no longer identifies any transponders. Subsequently, the processing device carries out a processing and an output and/or storage of the results.

For larger containers that are larger than the distance between the first antenna plane and the second antenna plane, in which case it is therefore probable that transponders will already be identified with the third antenna while other transponders are still being identified with the first antenna, it is advantageous if the transmitting and receiving device is set up so that first it also activates one antenna. During identification of transponders with the first antenna, as many transponders as possible are identified therewith and, simultaneously, the second antenna is alternatingly activated in the multiplexer mode and identifies as many transponders as possible. In this case, however, the third antenna is activated already when transponders are being identified with the second antenna. The first antenna is deactivated when it no longer identifies any transponders for a specific time, and the third antenna is kept in operation until it no longer identifies any transponders for a specific time. Thereafter, the processing device again carries out a processing and an output and/or storage of the results.

Passive transponders are usually activated by receiving a signal from the antenna, whereby the transponders are first loaded with power from the energy of the antenna and then send off their identification code. It is a substantial advantage for the identification device if the latter and the transponders are set up so that upon identification of each transponder it commands said transponder to switch into a mode (“quiet mode”) in which the transponder does not respond during the reception of signals from the antenna, usually for as long as the transponder is located in the antenna field and thus is supplied with power therefrom. The command for such a mode can be obeyed by the transponder for as long as it can remember it, which stops to be the case upon leaving the antenna field. However, this can be improved if the transponder has a mode optimized for the identification device (“quiet storage mode”), in which the transponder does not respond not only during the reception of signals, but also for a predetermined time thereafter. For this purpose the transponder needs to have a power supply with a corresponding storage capacity, thus allowing maintaining the optimized mode for a certain time. This time is determined by the energy capacity of the transponder and should correspond approximately to the transit time through the tunnel, which lies in the range of a few minutes.

In general, the number of objects in the container being transported through the tunnel will be known exactly or at least approximately. If, after such a container has passed through the tunnel, the number of identified transponders does not correspond to the number of objects in the container that should have a transponder, it may be advantageous if the conveyor device is set up so that the objects to be identified are movable in two directions. In this case the container can be moved back into the tunnel in order to identify the transponders that so far had not been identified. When doing so, the container can be moved back to reach the reading region of either the third, second or even first antenna, either in predetermined fashion or depending on the amount of correction. It will be understood that the expected number of transponders may be determined in a different way, e.g. by weighing of the container and thereby determining the expected number of objects in the container, if the container weight and the weight of the single objects provided with a transponder is known and the objects all have the same weight.

If in certain container loads one cannot rule out that two or more transponders will be so close to each other that they cannot be identified, it can be advantageous if the conveyor device is set up in such way that the arrangement of transponders can be changed during the reading process by means of a non-linear movement profile—preferably by means of a shaking movement—e.g. transversally to the transport direction, so as to increase the number of identifiable transponders upon passing onto the conveyor band.

In terms of processing, the object of the invention is achieved by means of a method for identifying objects, wherein the features of the invention ensure a correspondingly high probability that a large number of transponders will be identified in the tunnel; for smaller containers wherein the transmitting and receiving device initially activates the first antenna, whereupon during identification of transponders with the first antenna it identifies as many transponders as possible, then it alternatingly activates the second antenna in a multiplexer mode and identifies also as many transponders as possible with this antenna until the first antenna no longer identifies any transponders, whereupon it alternatingly activates the third antenna in a multiplexer mode and identifies as many transponders as possible with the second and the third antenna until the second antenna no longer identifies any transponders, whereupon it keeps the third antenna in operation until it no longer identifies any transponders, and that subsequently the processing device performs the processing and an output and/or storage of the results.

For larger containers, however, the above identified object is preferably achieved with the method wherein the transmitting and receiving device initially activates the first antenna, whereupon during identification of transponders with the first antenna it identifies as many transponders as possible, then it alternatingly activates the second antenna in a multiplexer mode and identifies also as many transponders as possible with this antenna, activates the third antenna during identification of transponders with the second antenna, deactivates the first antenna when the latter no longer identifies any transponders for a specific time, deactivates the second antenna when the latter no longer identifies any transponders for a specific time, and keeps in use the third antenna until the latter no longer identifies any transponders for a specific time, the processing device subsequently performing the processing and an output and/or storage of the results.

The identification capacity can again be increased if the transmitting and receiving device upon identification of each transponder commands said transponder to switch into a mode in which the transponder does not respond during reception of signals and for a time thereafter. Furthermore, the identification capacity can be increased if the conveyor device switches conveyor direction and conveys the objects back into the reading range of one, two or three antennas when a predefined number of transponders to be identified are missed by a deficit of predetermined amount after completion of the identification process. In addition or alternatively, it can be advantageous if the conveyor device changes the arrangement of the transponders during the reading process by means of a non-linear moving profile in another direction than the conveyor direction.

The features mentioned above as well as those recited in the claims and described in the following examples, which features are to be used according to this invention, do not have to meet any exceptional requirements with respect to size, shape, choice of material and technical conception, so that the selection criteria known in the applicable fields can be adopted without restrictions.

### BRIEF DESCRIPTION OF THE DRAWINGS

Further details, advantages and features of the subject of the present invention will be apparent from the following detailed description taken in conjunction with the accompanying drawings, wherein an identification device according to this invention and an identification method for objects with a transponder are explained in an exemplified form. In the following drawings

FIG. 1 shows an identification device according to a preferred embodiment of the present invention, in a perspective representation where the antennas are arranged under a shielding,

FIG. 2 shows the identification device according to FIG. 1, without the shielding, so that the antennas and their tuning devices are visible;

FIG. 3 shows the tunnel of the identification device according to FIG. 1, in a schematic representation; and

FIG. 4 shows a schematic representation of the circuitry logics for addressing the antennas according to FIG. 1.

### DETAILED DESCRIPTION OF THE INVENTION

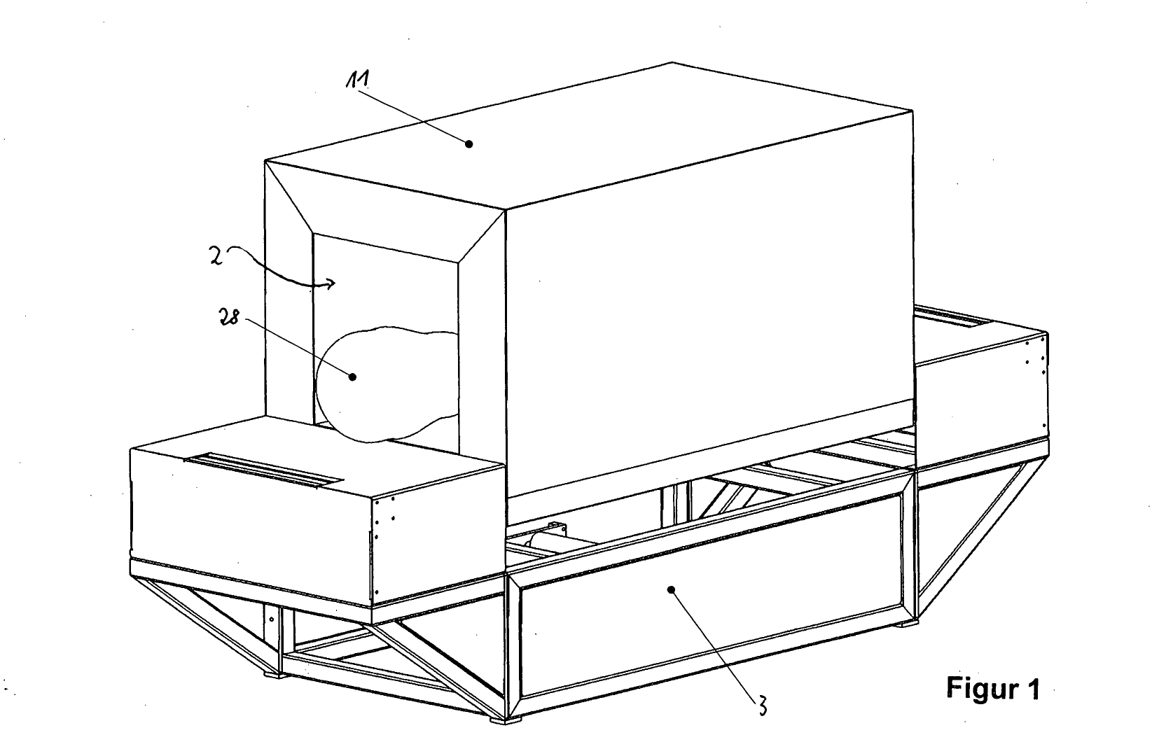

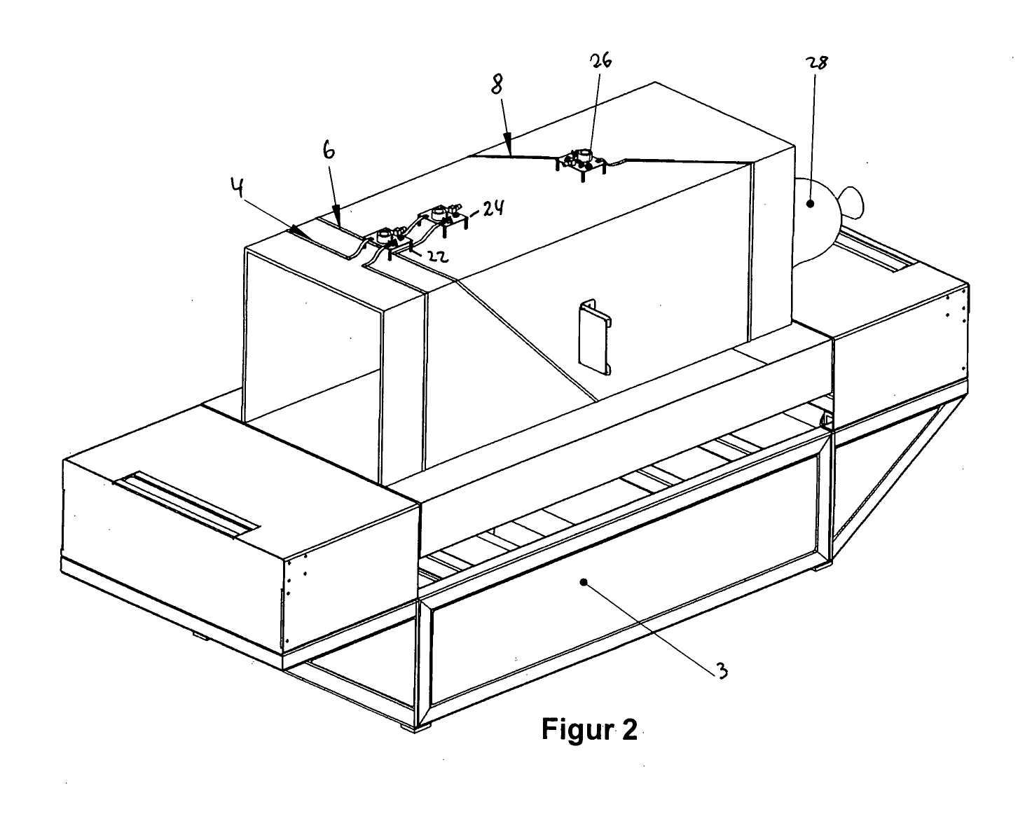

In an embodiment, the tunnel denoted as 2 in FIGS. 1 to 3 is provided with three antennas 4, 6 and 8 which are laid out as coils around the tunnel. On the bottom surface of tunnel 2 there is arranged conveyor device 3, namely a transport band for the transport containers containing the objects provided with transponders. In FIG. 2 the identification device is shown without the shielding 11 shown in FIG. 1, so that the tuning devices 22, 24 and 26 can be seen.

The normal of the plane of the first antenna 4 is parallel to the transport direction x of the conveyor band, and this direction is indicated as x′ in FIG. 1. In the present embodiment the first antenna 2 coincides with the tunnel entrance. The second antenna 6 is tilted (vertically) with respect to the first antenna 4 by an angle of about 45°. The normal of its plane is indicated as y′ in FIG. 1. An important feature of the present embodiment is that the center of the second antenna 6 lies approximately in the middle of the tunnel and is thus substantially displaced from the first antenna, and that the two antennas 4 and 6 neither contact nor overlap each other, but rather have a distance of about ⅓ of the tunnel length. The third antenna 8 is (laterally) twisted with respect to the first antenna 4 by an angle of about 45°. The normal of its plane is indicated as z′ in FIG. 1. A further important feature of the present embodiment is that a lateral edge of the third antenna 6 is approximately located at the end of the tunnel, whereas the other lateral edge is arranged at a substantial distance from the second antenna 6, and that the two antennas 6 and 8 also do not contact or overlap each other, but rather that their centers also have a distance of about ⅓ of the tunnel length.

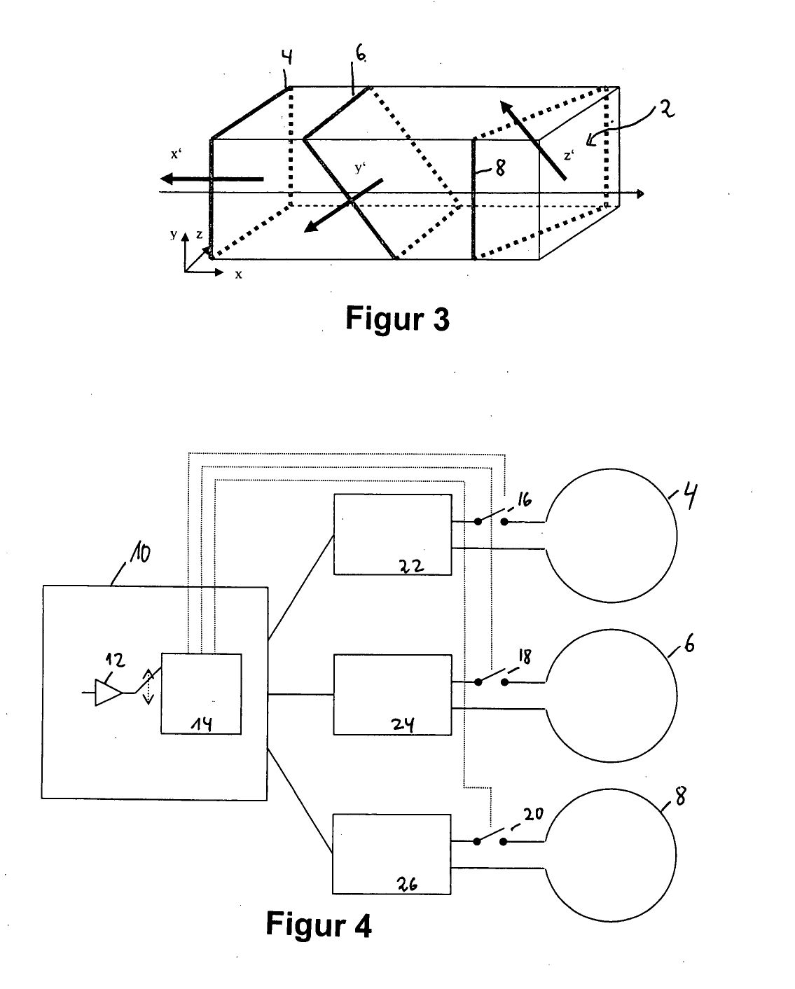

In the present embodiment, the antennas 4, 6 and 8 are addressed and read out by means of a switching device 10 with reading device, as shown schematically in FIG. 3.

The switching device has a multiplexer 14 that selectively distributes the electrical signals of the antenna amplifier 12 by means of a respective switch 16, 18 or 20 and a tuning device 22, 24 or 26 associated with one of the antennas 4, 6, or 8 and reads out the incoming signals from a respective one of these antennas. Further electronic circuitry is known in the art and will not be detailed in the description of the present embodiment.

Multiplexer 14 of switching circuit 10 is controlled in such way—in the present embodiment by means of a computer—as to perform one of the two procedures described hereinbelow.

For comparatively small containers 28 for the objects to be identified, i.e. for containers that are not larger than the distance between the first antenna plane x′ to the third antenna plane z′, in which case it is not probable that any transponders are already being identified with the third antenna 8 while other transponders are still being identified with the first antenna 4, the control is set up so that initially it activates the first antenna 4. During identification of transponders with the first antenna 4 as many transponders as possible are identified therewith and, simultaneously, the second antenna 6 is alternatingly activated in the multiplexer mode. At this point both activated antennas identify transponders until the first antenna 4 no longer identifies any transponders and is deactivated. In this moment, the third antenna 8 is activated in the multiplexer mode. By means of the second and third antenna 6 and 8, as many transponders as possible are identified until the second antenna 6 no longer identifies any transponders. Thereafter, the third antenna 8 is kept in operation until it no longer identifies any transponders. Subsequently, the processing device 10 carries out a processing and an output and/or storage of the results.

For comparatively large containers 28 that are larger than the distance between the first antenna plane x′ to the third antenna plane z′, in which case it is probable that transponders will already be identified with the third antenna 8 while other transponders are still being identified with the first antenna 4, the control is set up so that it also first activates antenna 4. During identification of transponders with the first antenna 4, as many transponders as possible are identified therewith, and as soon as the first transponders are identified, the second antenna 6 is alternatingly activated in the multiplexer mode. Also the second antenna activates as many transponders as possible, but the third antenna 8 is activated already when transponders are being identified with the second antenna 6. The first antenna 4 is deactivated when it no longer identifies any transponders for a specific time. Also the second antenna 6 is deactivated when it no longer identifies any transponders for a specific time. The third antenna 8 is again kept in operation until it no longer identifies any transponders for a specific time. Subsequently, the processing device 10 carries out a processing and an output and/or storage of the results.

In general, an identification device according to the present embodiment of the invention will always be fed with a specific type of containers, so that one of the two previously described operating modes can be permanently set up in the identification device. However, it is also possible—according to the present embodiment—to select one of the two operating modes via the computer or another inputting device.

In the present embodiment, the transmitting and receiving device 10 is set up in such way that upon identification of each transponder it commands the same to switch into a mode in which the transponder does not respond during the reception of signals and—if the transponder is configured accordingly and has a corresponding power supply for storing its mode—also for a time thereafter that corresponds to the transport time from a given antenna until the end of the tunnel.

In a second, alternative embodiment of the present invention the conveyor device can move the container 28 in Tunnel 2 in both directions. Accordingly, if the number of objects in the container 28 being transported through the tunnel is known exactly or approximately, it is possible to ascertain after the passage whether identification of all or at least nearly all transponders in the container was achieved. If, after such a container has passed through the tunnel 2, the number of identified transponders does not correspond to the number of objects in the container 28 that should have a transponder, according to the present embodiment the transport direction of the conveyor device is changed after passage of the container 28 so that the container 28 is transported back into the reading zone of the third, of the third and second or of all three antennas 8, 6, 4. For this purpose, the conveyor device is configured in such way that the objects to be identified are movable in two directions. In the present embodiment, the amount of deficit is used to determine whether container 28 is transported back into the reading zone of the third, second or even of the first antenna 8, 6, or 4, respectively. Alternatively, the expected number of transponders may be determined in a different way, e.g. by weighing of the container 28 on the conveyor is band by means of a corresponding weighing device so as to determine the expected number of objects in the container 28, if the container weight and the weight of the single objects provided with a transponder is known and the objects all have the same weight.

In a further embodiment, which may be combined with the first or the second embodiment, the conveyor device is configured in such way that the arrangement of the transponders is movable transversally to the transport direction during the reading process by means of a non-linear movement profile—in the present example by means of a shaking movement. If in certain container loads one cannot rule out that two or more transponders will be so close to each other that they cannot be identified, such shaking profile can be used to change the arrangement of transponders during the reading process so as to increase the number of transponders that are identifiable upon transit on the transport band.

### LIST OF REFERENCE NUMERALS

2 identification tunnel
3 conveyor device
4 first antenna
6 second antenna
8 third antenna
10 switching device with reader device
11 shielding
12 antenna amplifier
14 multiplexer
16 switch for first antenna
18 switch for first antenna
20 switch for third antenna
22 antenna tuning device for first antenna
24 antenna tuning device for second antenna
26 antenna tuning device for third antenna
28 container for testing body
x transport direction of container
x′ normal of first antenna plane
y′ normal of second antenna plane
z′ normal of third antenna plane

1. An identification device for objects, each of which comprises a transponder, with a conveyor device for the objects to be identified, the conveyor device comprising a tunnel through which the objects to be identified are transportable, a transmitting and receiving device for communication with the transponders of the objects to be identified, the transmitting and receiving device comprising an processing device and an antenna device, the antenna device comprising at least three sequentially arranged coil-shaped antennas that surround the tunnel, at least three of the antennas that surround the tunnel lying each in a different plane (x′, y′, z′), the planes (x′, y′, z′) representing a linearly independent system wherein said antenna planes (x′, y′, z′) do not intersect or contact each other within the tunnel.

2. The identification device according to claim 1, wherein said transmitting and receiving device (10) comprises a multiplexer (14) that is set up in such a way that the antennas (4, 6, 8) are operable in the multiplexer mode.

3. The identification device according to claim 1, wherein said antenna planes (x′, y′, z′) have a displacement of at least 10 mm within the tunnel (2).

4. The identification device according to claim 1, wherein one of said planes (x′) is perpendicular to the normal of the conveyor band.

5. The identification device according to claim 4, wherein said transmitting and receiving device is set up in such a way that initially it activates the first antenna, whereupon during identification of transponders with the first antenna it identifies as many transponders as possible, and that following the first identification of transponders with the first antenna it alternatingly activates the second antenna in a multiplexer mode and identifies as many transponders as possible with these two antennas until the first antenna no longer identifies any transponders, whereupon it alternatingly activates the third antenna in a multiplexer mode and identifies as many transponders as possible by the second and the third antenna until the second antenna no longer identifies any transponders, whereupon it keeps the third antenna in operation until it no longer identifies any transponders, and that subsequently the processing device performs the processing and an output and/or storage of the results.

6. The identification device according to claim 4, wherein said transmitting and receiving device is set up in such a way that initially it activates the first antenna, whereupon during identification of transponders with the first antenna (4) it identifies as many transponders as possible, and that following the first identification of transponders with the first antenna it alternatingly activates the second antenna in a multiplexer mode and it identifies as many transponders as possible with these two antennas, whereupon already during identification of transponders with the second antenna it activates the third antenna, it deactivates the first antenna, when the latter no longer identifies any transponders for a specific time, it deactivates the second antenna, when the latter no longer identifies any transponders for a specific time, and it keeps in use the third antenna, until the latter no longer identifies any transponders for a specific time, and that subsequently the processing device performs the processing and an output and/or storage of the results.

7. The identification device according to claim 1, wherein said transmitting and receiving device is set up in such a way that upon identification of each transponder it commands said transponder to switch into a mode in which the transponder does not respond during the reception of signals and for a time thereafter.

8. The identification device according to claim 1, wherein said device is set up in such a way that the objects to be identified are movable in two directions.

9. The identification device according to claim 8, wherein it is set up in such a way that a specific number of transponders to be identified can be predefined, and that in the presence of a deficit of predetermined amount after the completion of the identification process the conveyor direction of the conveyor device is switched into the reading range of one, two or three antennas so as to allow identification of further transponders not identified as yet.

10. The identification device according to any one of claims 1, wherein said conveyor device is set up in such a way that the arrangement of the transponders can be changed during the reading process by means of a non-linear movement profile in another direction than the conveyor direction, so as to increase the number of identifiable transponders upon passing onto the conveyor band.

11. A method for identifying objects, each of which comprises a transponder, by means of an identification device that comprises a conveyor device for the objects to be identified, the conveyor device comprising a tunnel, through which the objects to be identified are transportable, the identification device further comprising a transmitting and receiving device for communication with the transponders of the objects to be identified, the transmitting and receiving device comprising an antenna device and an processing device, the antenna device comprising at least three sequentially arranged coil-shaped antennas, the antenna coils surrounding the tunnel, operating the antennas in the multiplexer mode.

12. The method for identifying objects according to claim 11, wherein said transmitting and receiving device initially activates the first antenna, whereupon during identification of transponders with the first antenna it identifies as many transponders as possible, then it alternatingly activates the second antenna in a multiplexer mode and identifies also as many transponders as possible with this antenna until the first antenna no longer identifies any transponders, whereupon it alternatingly activates the third antenna in a multiplexer mode and identifies as many transponders as possible with the second and the third antenna until the second antenna no longer identifies any transponders, whereupon it keeps the third antenna in operation until it no longer identifies any transponders, and that subsequently the processing device performs the processing and an output and/or storage of the results.

13. The method for identifying objects according to claim 11, wherein said transmitting and receiving device initially activates the first antenna, whereupon during identification of transponders with the first antenna it identifies as many transponders as possible, then it alternatingly activates the second antenna in a multiplexer mode and identifies also as many transponders as possible with this antenna, activates the third antenna during identification of transponders with the second antenna, deactivates the first antenna when the latter no longer identifies any transponders for a specific time, deactivates the second antenna when the latter no longer identifies any transponders for a specific time, and keeps in use the third antenna until the latter no longer identifies any transponders for a specific time, the processing device subsequently performing the processing and an output and/or storage of the results.

14. The method for identifying objects according to claim 11, wherein said transmitting and receiving device upon identification of each transponder commands said transponder to switch into a mode in which the transponder does not respond during reception of signals and for a time thereafter.

15. The method for identifying objects according to claim 11, wherein said conveyor device switches conveyor direction and conveys the objects back into the reading range of one, two or three antennas when a predefined number of transponders to be identified is missed by a deficit of predetermined amount after completion of the identification process.

16. The method for identifying objects according to claim 11, wherein said conveyor device changes the arrangement of the transponders during the reading process by means of a non-linear moving profile in another direction than the conveyor direction.
